(19) United States
(12) Patent Application Publication
(10) Pub. No.: US 2019/0229477 A1
(43) Pub. Date: Jul. 25, 2019

(54) CONNECTING CABLE AND DRIVING SYSTEM

(71) Applicant: LIMOSS (SHENZHEN) CO., LTD., Shenzhen, Guangdong (CN)

(72) Inventor: Christian Gassner, Shenzhen, Guangdong (CN)

(21) Appl. No.: 16/326,389

(22) PCT Filed: Jun. 4, 2018
(86) PCT No.: PCT/CN2018/089811

§ 371 Date: Feb. 19, 2019

(30) Foreign Application Priority Data
Jun. 6, 2017 (CN) 201720653972.X

(51) Int. Cl. H01R 25/00; H01R 13/50

(52) U.S. Cl. CPC H01R 25/003; H01R 24/28; H01R 13/50

(57) ABSTRACT

A connecting cable and a driving system are provided. The connecting cable comprises a main cable, a plurality of sub-branch cables and a plurality of protecting members, wherein the main cable is arranged with a first terminal at one end, and an end of each of the sub-branch cables is connected with the main cable, respectively; the other end of the main cable and the other end of each of the sub-branch cables are respectively arranged with a second terminal having a plug interface, and each protecting member respectively encloses each joint between each sub-branch cables and the main cable and is fixedly arranged at the joint. When supplying driving circuits for a plurality of actuators by means of the connecting cable, the plurality of actuators can be respectively connected through plug interfaces to one connecting cable.

### FIELD OF THE INVENTION

The present invention relates to electric power transmission devices, more particularly to a connecting cable and a driving system.

### BACKGROUND OF THE INVENTION

The actuator is an electromotive transmission device used for lifting, lowering or rotating equipment such as medical beds, electric beds, power seats, and household massage chairs. Usually, a power supply is required to actually actuate the actuator. To provide an actuator for a row of power seats, it is necessary to arrange a transformer for transforming the mains power therebetween, so as to enable a stable power source for the actuator by the mains power. Existing connecting cable for actuators may be arranged with a power plug at one end, and at the other end with a sole male plug that may be connected to an actuator. Each actuator is configured individually with a respective connecting cable. In the case that a plurality of actuators are provided, a plurality of individual connecting cables are required. In such case, too many connecting cables lead to a waste of resource, and may cause confusion in the application fields and also easily cause mistakes during assembly and maintenance.

### SUMMARY OF THE INVENTION

The present invention aims to provide a connecting cable and a driving system, to solve the problem of conventional driving circuits for actuators that confusions and disorders of the cables in the fields may result in mistakes during assembly and maintenance.

The present invention provides a connecting cable, which comprises a main cable, a plurality of sub-branch cables and a plurality of protecting members, wherein the main cable is arranged with a first terminal at one end, and an end of each of the sub-branch cables is connected with the main cable, respectively; the other end of the main cable and the other end of each of the sub-branch cables are respectively arranged with a second terminal having a plug interface, and each protecting member respectively encloses each joint between each sub-branch cables and the main cable and is fixedly arranged at the joint.

Preferably, the first terminal is a power plug.

Preferably, the plug port has a centrosymmetric cross section.

Preferably, the second terminal comprises a terminal body, and the plug port is arranged with a plug portion coupled at one side of the terminal body and longitudinally extending outwards from the said side, and with at least one electrode formed at the plug portion, wherein, the plug portion has a width, a height, and a length, and comprises an insulating frame defining a shape of the plug portion, wherein the insulating frame has a first and a second side surfaces which extend along the width direction and the length direction and are opposite to each other, a third and a fourth side surfaces which extend between the first and the second side surfaces along the height direction and the length direction and are opposite to each other, and an end portion extending along the width direction and the height direction at the outer end of the insulating frame.

Preferably, the outer end surface of the end portion of the insulating frame is provided with at least one opening, which opening extends towards the terminal body, and the electrode is disposed inside the opening.

Preferably, the electrode is an electrode pin, which is fixed to the bottom wall of the opening and longitudinally extends outwards.

Preferably, the electrode is an electrode contact, which is formed on the inner wall of the opening.

Moreover, a driving system is further provided, which comprises the above connecting cable and a plurality of loads which can be actuated by the connecting cable, wherein each of the loads is respectively connected with respective second terminal by pluggable connection.

Preferably, all the loads are actuators or transformers.

When supplying driving circuits for a plurality of actuators by means of the above connecting cable and the driving system, the plurality of actuators can be respectively connected through plug interfaces to one connecting cable. In such a manner, confusions and disorders of the cables in the fields can be avoided, whereby the risk of making mistakes during assembly and maintenance is lowered. The cables can be neatly arranged in the fields.

### BRIEF DESCRIPTION OF THE DRAWINGS

FIG. 1 is a schematic drawing of a connecting cable according to a preferred embodiment of the present invention;

FIG. 2 is a schematic drawing of a first end of the connecting cable shown in FIG. 1;

FIG. 3 is a schematic drawing illustrating, in a first embodiment, a second end of the connecting cable shown in FIG. 1;

FIG. 4 is a schematic drawing illustrating, in a second embodiment, a second end of the connecting cable shown in FIG. 1.

### DETAILED DESCRIPTION OF ILLUSTRATED EMBODIMENTS

In order to illustrate technical problems to be solved, technical solutions and advantages more clearly, the present invention is further described below in conjunction with figures and embodiments. It should be understood that particular embodiments described herein are illustrative rather than limiting.

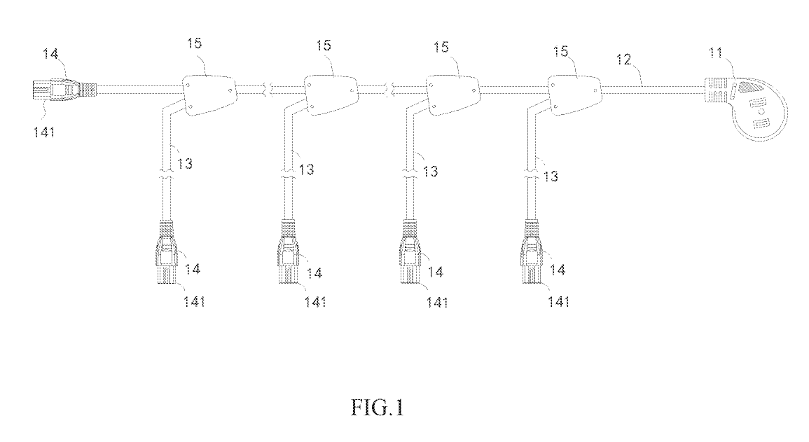

Referring to FIG. 1, in a preferred embodiment of the present invention, a connecting cable comprises a main cable 12, a plurality of sub-branch cables 13 and a plurality of protecting members 15, wherein the main cable 12 is arranged with a first terminal 11 at one end, and an end of each of the sub-branch cables 13 is connected with the main cable 12, respectively; the other end of the main cable 12 and the other end of each of the sub-branch cables 13 are respectively arranged with a second terminal 14 having a plug interface 141, and each protecting member 15 respectively encloses each joint between each sub-branch cables 13 and the main cable 12 and is fixedly arranged at the joint. In general, the number of the sub-branch cables 13 is equal to the number of the protecting members 15, and also, the length of the main cable 12 and the numbers of the sub-branch cables 13 and of the protecting members 15 can be determined depending on the actual application. Since the plurality of sub-branch cables 13 are respectively protected by the plurality of protecting members 15, even in the event of a fault of one of the sub-branch cables 13, other sub-branch cables' functions and even the whole connecting cable's function can be unaffected.

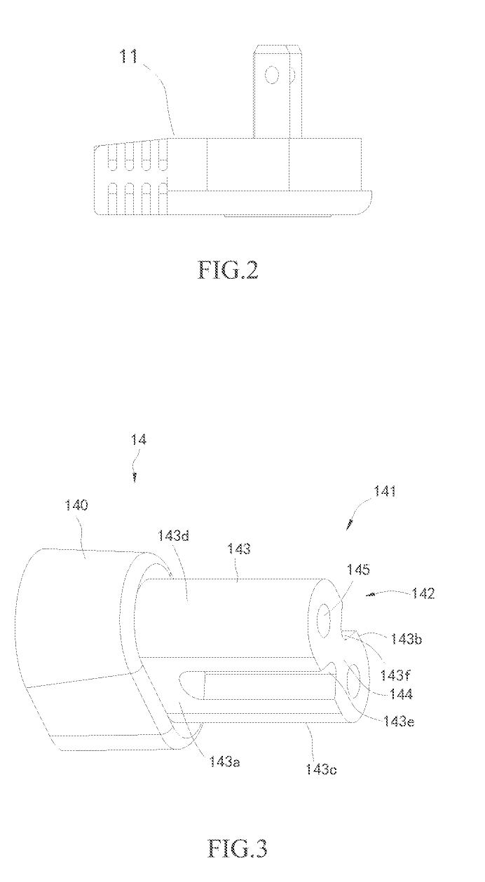

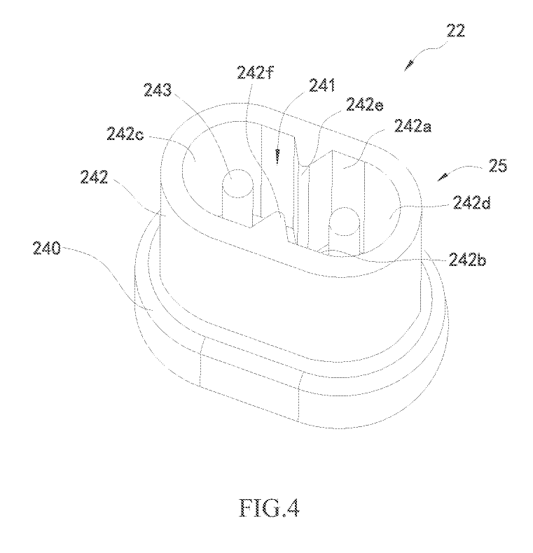

Referring to FIG. 2, the first terminal 11 in an embodiment may be a power plug which can be plugged into a mains power interface. In other embodiments, the first terminal 11 may be an interface having a plug port 141, as shown in FIG. 3; or, the first terminal 11 may be an interface having a port mated with the plug port 141, as shown in FIG. 4.

Furthermore, referring to FIGS. 3 and 4, the plug port 141 of the second terminal 14 has a centrosymmetric cross section and thus has no different between the front and back sides, thereby facilitating plug connection. The plug port 141 may be a male plug or a female socket.

In an embodiment, the plug port 141 may be a male plug. Referring to FIG. 3, the second terminal 14 comprises a terminal body 140, and the plug port 141 is arranged with a plug portion 142 coupled at one side of the terminal body 140 and longitudinally extending outwards from the said side, and with at least one electrode formed at the plug portion 142. Herein, the plug portion 142 has a width, a height, and a length, and comprises an insulating frame 143 defining a shape of the plug portion 142, wherein the insulating frame 143 has a first and a second side surfaces 143a, 143b which extend along the width direction and the length direction and are opposite to each other, a third and a fourth side surfaces 143c, 143d which extend between the first and the second side surfaces 143a, 143b along the height direction and the length direction and are opposite to each other, and an end portion 144 extending along the width direction and the height direction at the outer end of the insulating frame 143.

In the embodiment, the outer end surface of the end portion 144 of the insulating frame 143 is provided with at least one opening 145, which opening extends towards the terminal body 140, and the electrode is disposed inside the opening 145. Herein, the electrode may be an electrode pin, which is fixed to the bottom wall of the opening 145 and longitudinally extends outwards. Alternatively, the electrode may be an electrode contact, which is formed on the inner wall of the opening 145. The insulating frame 143 is provided for the connection of the connecting cable with a load, and also for the insulation protection of the electrode.

In addition, grooves 143e, 143f are respectively provided in the middle parts of the first side surface 143a and the second side surface 143b of the insulating frame 143 of the interface which serves as a male plug, and the two grooves 143e, 143f extend towards the main body 140 from the outer end surface. In such configuration, due to the corresponding grooves 143e, 143f arranged on the male plug, it is beneficial to reinforce the strength of the female socket and the male plug, reducing deformation and breakage caused by external pulling and pushing forces.

In a further embodiment, the plug port 141 may be a female socket. Referring to FIG. 4, the second terminal 14 comprises a terminal body 240, the plug port 141 is provided with an opening 241 formed on one side of the terminal body 240 and longitudinally extending inwards from a surface of the said side, an insulating frame 242 defining a shape of the plug port 141, and at least one electrode 243 fixed to the insulating frame 242 and disposed inside the second opening 241. Herein, the insulating frame 242 has a bottom wall at the inner end, and a plurality of inner walls connected with the bottom wall and longitudinally extending outwards, wherein the plurality of inner walls comprise a first and a second inner walls 242a, 242b which are opposite to each other, and a third and a fourth inner walls 242c, 242d which extend between the first and the second inner walls 242a, 242b and are opposite to each other.

In the embodiment, the electrode 243 may be an electrode pin, which is fixed to the bottom wall of the insulating frame 242 and longitudinally extends outwards. In other embodiments, the electrode 243 may be a metal contact formed on the bottom wall of the insulating frame 242. The insulating frame 242 is provided for the connection of the connecting cable, and also for the insulation protection of the electrode.

Furthermore, protruding ribs 242e, 242f are respectively arranged in the middle parts of the first inner wall 242a and the second inner wall 242b of the insulating frame 242 of the interface which serves as a female socket, and the two protruding ribs 242e, 242f are formed opposite to each other and extend towards the bottom wall (the body 240) from the outer end surface. Due to the protruding ribs 242e, 242f arranged on the female socket, it is beneficial to reinforce the strength of the female socket and the male plug, reducing deformation and breakage caused by external pulling and pushing forces.

For example, referring to FIG. 1, in order to supply driving circuits for five actuators or transformers, each of the actuators may be correspondingly connected to the second terminal 14, respectively. In such case, a connecting cable having five second terminals 14 can be provided. In this way, five actuators or transformers are incorporated in the circuit by one connecting cable, with no excess interface or cable being left. In such a manner, the cables can be neatly arranged in the fields, whereby the risk of making mistakes during assembly and maintenance is lowered. It will be understood that the sub-branch cables 13 of the connecting cable can be provided as required, for example the number thereof can be changed, or the type thereof can be changed.

Moreover, the present invention further provides a driving system, comprising the above connecting cable and a plurality of loads which can be actuated by the connecting cable, wherein each of the loads is respectively connected with respective second terminal by pluggable connection. Preferably, all the loads are actuators (not shown) or transformers (not shown). For example, the second terminal of the connecting cable is directly electrically connected to the actuator, or it is electrically connected to the transformer and meanwhile the transformer is connected to the actuator. The actuator can be applied to transmission devices such as power seats and electric beds, and the transformation requirement of the actuator can be meet appropriately by means of the transformer.

When supplying driving circuits for a plurality of actuators by means of the above connecting cable and the driving system, the plurality of actuators can be respectively connected through plug interfaces to one connecting cable. In such a manner, confusions and disorders of the cables in the fields can be avoided, whereby the risk of making mistakes during assembly and maintenance is lowered. The cables can be neatly arranged in the fields.

All the above merely illustrate preferred embodiments of the present invention, but are not to limit the invention in any form. The present invention is intended to cover all changes, equivalent arrangements and various modifications included within the spirit and principle of the present invention.

1. A connecting cable, comprising a main cable, a plurality of sub-branch cables and a plurality of protecting members; wherein the main cable is arranged with a first terminal at one end, and an end of each of the sub-branch cables is connected with the main cable, respectively; the other end of the main cable and the other end of each of the sub-branch cables are respectively arranged with a second terminal having a plug interface, and each protecting member respectively encloses a joint between each of the sub-branch cables and the main cable and is fixedly arranged at the joint.

2. The connecting cable according to claim 1, wherein the first terminal is a power plug.

3. The connecting cable according to claim 1, wherein the plug port has a centro symmetric cross section.

4. The connecting cable according to claim 1, wherein the second terminal comprises a terminal body, and the plug port is arranged with a plug portion coupled at one side of the terminal body and longitudinally extending outwards from the side, and with at least one electrode formed at the plug portion, wherein, the plug portion has a width, a height, and a length, and comprises an insulating frame defining a shape of the plug portion, wherein the insulating frame has a first and a second side surfaces which extend along the width direction and the length direction and are opposite to each other, a third and a fourth side surfaces which extend between the first and the second side surfaces along the height direction and the length direction and are opposite to each other, and an end portion extending along the width direction and the height direction at an outer end of the insulating frame.

5. The connecting cable according to claim 4, wherein an outer end surface of the end portion of the insulating frame is provided with at least one opening, which opening extends towards the terminal body, and the electrode is disposed inside the opening.

6. The connecting cable according to claim 5, wherein the electrode is an electrode pin, which is fixed to a bottom wall of the opening and longitudinally extends outwards.

7. The connecting cable according to claim 5, wherein the electrode is an electrode contact, which is formed on an inner wall of the opening.

8. A driving system, comprising a connecting cable according to claim 1, and a plurality of loads which can be actuated by the connecting cable, wherein each of the loads is respectively connected with respective second terminal by pluggable connection.

9. The driving system according to claim 8, wherein all the loads are actuators or transformers.

10. The connecting cable according to claim 3, wherein the second terminal comprises a terminal body, and the plug port is arranged with a plug portion coupled at one side of the terminal body and longitudinally extending outwards from the side, and with at least one electrode formed at the plug portion, wherein, the plug portion has a width, a height, and a length, and comprises an insulating frame defining a shape of the plug portion, wherein the insulating frame has a first and a second side surfaces which extend along the width direction and the length direction and are opposite to each other, a third and a fourth side surfaces which extend between the first and the second side surfaces along the height direction and the length direction and are opposite to each other, and an end portion extending along the width direction and the height direction at an outer end of the insulating frame.

11. A driving system, comprising a connecting cable according to claim 2, and a plurality of loads which can be actuated by the connecting cable, wherein each of the loads is respectively connected with respective second terminal by pluggable connection.

12. A driving system, comprising a connecting cable according to claim 3, and a plurality of loads which can be actuated by the connecting cable, wherein each of the loads is respectively connected with respective second terminal by pluggable connection.

13. A driving system, comprising a connecting cable according to claim 4, and a plurality of loads which can be actuated by the connecting cable, wherein each of the loads is respectively connected with respective second terminal by pluggable connection.

14. A driving system, comprising a connecting cable according to claim 5, and a plurality of loads which can be actuated by the connecting cable, wherein each of the loads is respectively connected with respective second terminal by pluggable connection.

15. A driving system, comprising a connecting cable according to claim 6, and a plurality of loads which can be actuated by the connecting cable, wherein each of the loads is respectively connected with respective second terminal by pluggable connection.

16. A driving system, comprising a connecting cable according to claim 7, and a plurality of loads which can be actuated by the connecting cable, wherein each of the loads is respectively connected with respective second terminal by pluggable connection.

17. A driving system, comprising a connecting cable according to claim 10, and a plurality of loads which can be actuated by the connecting cable, wherein each of the loads is respectively connected with respective second terminal by pluggable connection.

18. The driving system according to claim 11, wherein all the loads are actuators or transformers.

19. The driving system according to claim 12, wherein all the loads are actuators or transformers.

20. The driving system according to claim 17, wherein all the loads are actuators or transformers.
